(19) United States
(12) Patent Application Publication
(10) Pub. No.: US 2024/0145734 A1
(43) Pub. Date: May 2, 2024

(54) BILAYER SHRINKAGE TO ASSEMBLE COMPLEX CERAMIC SHAPES

(71) Applicants: Alexander Hartwell, Springfield, MA (US); Jeongmin Ahn, Manlius, NY (US)

(72) Inventors: Alexander Hartwell, Springfield, MA (US); Jeongmin Ahn, Manlius, NY (US)

(73) Assignee: Syracuse University, Syracuse, NY (US)

(21) Appl. No.: 18/495,350

(22) Filed: Oct. 26, 2023

Related U.S. Application Data
(60) Provisional application No. 63/419,480, filed on Oct. 26, 2022.

(51) Int. Cl. H01M 4/90; C25B 11/077; H01M 4/88; H01M 8/1226; H01M 8/1253

(52) U.S. Cl. CPC H01M 4/9016; C25B 11/077; H01M 4/8857; H01M 4/8885; H01M 8/1226; H01M 8/1253; H01M 2004/8684

(57) ABSTRACT

A method of forming complex ceramic structures without altering the ceramic microstructure. A tape cast ceramic substrate is masked and then sprayed with a film having a different thermal expansion coefficient than the tape cast ceramic substrate. The mask is removed to leave the desired pattern of film on the tape ceramic substrate. As the substrate and film cools down from the peak sintering temperature, deformation occurs due to the different thermal expansion coefficients. By varying film thickness and deposition pattern, the composite can be designed to deform only in certain areas, allowing for well-controlled folding of the tape cast ceramic composite to provide for folding into complex shapes.

### CROSS-REFERENCE TO RELATED APPLICATION

The present application claims priority to U.S. Provisional Application No. 63/419,480 filed on Oct. 26, 2022.

### BACKGROUND OF THE INVENTION

### 1. Field of the Invention

The present invention relates to ceramics manufacturing and, more specifically, an approach for assembling ceramic composites including solid oxide fuel cells, solid oxide electrolyzers, and reactions chambers into complex shapes.

### 2. Description of the Related Art

Though millennia of ceramics manufacturing have allowed for the production of an unimaginable assortment of stunning structures and intricate objects, there are still limitations on what can be made via commercial and even artisanal techniques. For example, structures with internal elements such as shells with internal grids or interlocked structures like chains cannot be produced without bonding separate ceramic pieces, ultimately yielding mechanically inferior final products.

The desire to eliminate these geometric limitations has prompted many creative approaches to form complex, self-assembling ceramic structures. Some have produced curved ceramic structures by magnetically controlling the orientation of ceramic platelets within the ceramic slurry, causing anisotropic shrinkage during the sintering process. Others have utilized 3D-printing to assemble parallel ceramic filaments into a sheet and then stack multiple sheets at varying orientations, again causing anisotropic shrinkage during sintering, ultimately yielding complexly curved ceramic shapes. Both of these solutions are powerful additions to the field of ceramics manufacturing but are coupled with some limitations. In both cases, the self-assembly is a result of carefully controlled ceramic microstructure.

In some applications, however, such as with micro-electro-mechanical systems (MEMS) or solid oxide fuel cells (SOFCs), it is desired to avoid alteration to the ceramic microstructure, necessitating the development of an alternate manufacturing method for these complex shapes. Accordingly, there is a need in the art for an approach that can provide complex shapes without altering the ceramic microstructure.

### BRIEF SUMMARY OF THE INVENTION

The present invention provides a manufacturing approach that can produce complex ceramic structures such as in solid oxide fuel cells (SOFCs) without the need to alter the ceramic microstructure. Multilayer ceramic composites are manufactured by applying thin film to a thick substrate which provides physical support, where the thin films and the substrate have different thermal expansion coefficients. Hard, dense ceramics are then formed by sintering the assembly at temperatures exceeding 1000° C. Because the substrate and the applied film have different thermal expansion coefficients, when the composite cools down from the peak sintering temperature deformation occurs. Instead of minimizing deformation, which is the typical approach to form working SOFCs, the present invention accentuates deformation and dictates the amount and location of deformation by patterning the application of the thin films. By varying film thickness and deposition pattern, the composite can be designed to deform only in certain areas, allowing for well-controlled folding of the sheet producing the “mountain” and “valley” folds found in traditional origami that allow for folding into complex shapes.

In a first aspect, the invention comprises a ceramic composite having a complete shape that is formed by a tape cast ceramic substrate having a first thermal expansion coefficient and at least a first film positioned on a first side of the tape cast ceramic substrate having a second thermal expansion coefficient that is different than the first thermal expansions coefficient. The tape cast ceramic substrate may be formed from an anodic material. The first film may be formed from an electrolyte material. A second film having the second thermal expansion coefficient may be positioned on a second side of the tape cast ceramic substrate. The anodic material may be NiO and YSZ. The anodic material may have the formula NiO+(ZrO₂)_{0.92} (Y₂O₃)_{0.08} and the NiO and YSZ are present in a ratio of 60:40 by weight. The electrolyte material may be YSZ. The first mask and the second mask may be formed from a polymer.

In another aspect, the present invention is a method of forming a ceramic composite into a complex shape. The method includes the step of providing a tape cast ceramic substrate having a first thermal expansion coefficient. The method further includes the step of applying at least a first mask having a predetermined geometry to a first side of the tape cast ceramic substrate. The method additionally includes the step of spraying at least a first film having a second thermal expansion coefficient that is different than the first thermal expansion coefficient over the mask and onto the tape cast ceramic substrate. The method further includes the step of removing the first mask from the tape cast ceramic composite. The method also includes the step of sintering the tape cast ceramic composite. The method may include the step of applying a second mask having a second predetermined geometry to a second side of the tape cast ceramic substrate prior to the step of sintering the tape case ceramic composite. The method may further include the step of spraying a second film having the second thermal expansion coefficient over the second mask and onto the tape cast ceramic substrate prior to the step of sintering the tape case ceramic composite. The method may additionally include the step of removing the second mask from the tape cast ceramic composite prior to the step of sintering the tape case ceramic composite. The tape cast ceramic substrate may be formed from an anodic material. The first film may be formed from an electrolyte material. A second film having the second thermal expansion coefficient may be positioned on a second side of the tape cast ceramic substrate. The anodic material may be NiO and YSZ. The anodic material may have the formula NiO+(ZrO₂)0.92(Y₂O₃)0.08 and the NiO and YSZ are present in a ratio of 60:40 by weight. The electrolyte material may be YSZ. The first mask and the second mask may be formed from a polymer.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a flow diagram showing film deposition for self-assembling ceramic structures according to the present invention.

FIG. 2 is a schematic showing (top) dimensions of two-dimensional finite element analysis bilayer test structure and (bottom) mesh of bilayer showing coarse mesh within substrate and fine mesh in film.

FIG. 3 is a plot showing the dependence of composite curvature on film and anode thicknesses relative to a theoretical value in the field.

FIG. 4 is a schematic showing the evolution from high temperature (top) to low temperature (bottom) of a bilayer with inversely varying film thicknesses on top and bottom surfaces leading to an S-curve.

FIG. 5 is (top) a finite element analysis (FEA) of a three-dimensional bilayer test structure experiencing bilayer shrinkage with color representing von Mises stress and (bottom) an image of a dry-pressed cell with similar characteristic curvature to the 3D-FEA structure.

FIG. 6 is an image of a crack array on electrolyte surface where the black dashed line indicates axis of curvature.

FIG. 7 is an image of a variety of tape cast ceramic composites exhibiting tube-like deformation (leftmost) and frustrated deformation patterns (second from left to rightmost).

FIG. 8 is an image of, from left to right, a sunflower cell, a tube cell, and a wave cell formed using bilayer shrinkage of ceramic composites according to the present invention.

FIG. 9 is a schematic showing process for producing self-shaping ceramic with radius of curvature

$$\\ r = \frac{1}{κ} ,$$

thickness of film t₁, thickness of substrate t₂, chord length l, and arc length S.

FIG. 10 is a graph showing experimental samples for substrate thicknesses of 150 and 380 μm, analytical prediction of curvature obtained using equation 10 for substrate thickness of 100, 150, and 380 μm, 2D 3D FEM model curvatures for substrate thicknesses of 100 and 150 μm.

FIG. 11 is a diagram of starting 2D sheet shape and final deformed sheet shown for disks of 5 mm radius and 10 mm radius (left), squares with side lengths of 20 mm and 10 mm (right), and rectangle of dimensions 10 mm×20 mm (bottom). Substrate thickness is 150 μm and film thickness is 20 μm. Scale bar is 5 mm.

FIG. 12 is model of a square with side length of 20 mm, substrate and film thicknesses of 150 μm and 20 μm respectively at 686° C. (top) and 22.5° C. (bottom) experiencing bilayer shrinkage.

FIG. 13 is a model of circle with radius of 5 mm, substrate and film thicknesses of 150 μm and 20 μm.

FIG. 14 is a model of a rectangle with size 20 mm×10 mm, substrate and film thicknesses of 150 μm and 20 μm respectively at 686° C. (top) and 22.5° C. (bottom) experiencing bilayer shrinkage.

FIG. 15 is an image shows rectangle with alternating zones of film coating on top and bottom of substrate yielding wave-like deformation (top) with inset image showing experimental sample with same film pattern and a 2D sheet shape and film pattern producing an origami crane (bottom).

### DETAILED DESCRIPTION OF THE INVENTION

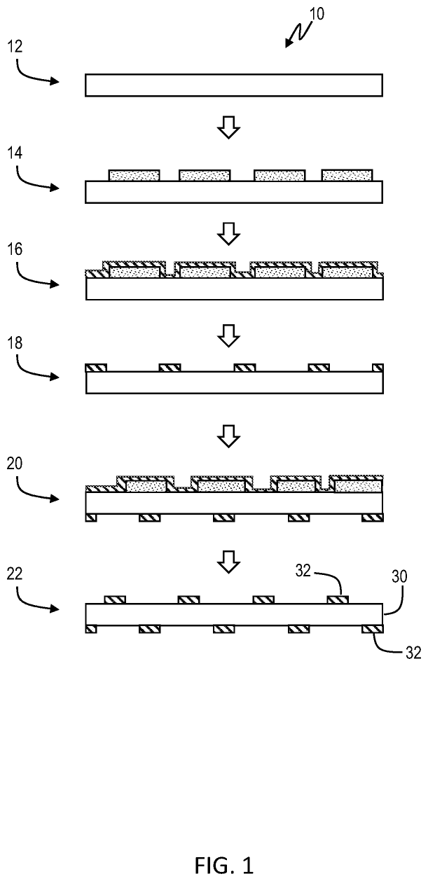

Referring to the figures, wherein like numeral refer to like parts throughout, there is seen in FIG. 1 a process 10 for forming tape cast ceramic composites into three dimensional shapes by depositing a patterned contracting film to provide controlled deformation. By ultrasonically spray-coating a contracting ceramic film with greater thermal expansion coefficient than the substrate onto a tape-casted substrate, residual stresses will develop and provide controllable deformation of the ceramic structure. Using three-dimensional printed masks to control the film deposition pattern and by cutting the substrate sheet, process 10 can be used to produce a wide variety of structures.

As seen in FIG. 1, process 10 begins by tape casting a substrate 12 having a first thermal expansion coefficient. Next, a mask is applied to the substrate 14. A film having a second thermal expansion coefficient that is difference than the first thermal expansion coefficient is then sprayed over the masked substrate 16. The mask is then removed 18, leaving the patterned film on the substrate. Process 10 the continues with a second mask applied to the opposing side of the substrate 20. The masked substrate is then sprayed with a film 22. The mask is then removed 24 leaving the patterned film on the second side of the substrate. The patterned film and substrate are then sintered 26 to provide a substrate 30 of a first thermal expansion coefficient having patterned film 32 of a second, different thermal expansion coefficient positioned on both sides of substrate 30. As explained below, substrate 30 may be a conventional SOFC anode material, such as NiO+YSZ, and film 32 may be an electrolyte, such as YSZ. Subsequent heating of substrate 30 and film 32 producing folding into a three-determined structure having a shape defined by the patterns used when applying film 32 to the opposing sides of substrate 30.

### EXAMPLE 1

Typical SOFC anode and electrolyte materials formed the substrate and film respectively. The anode substrate consisted of a NiO+YSZ (NiO+(ZrO₂)0.92(Y₂O₃)0.08, 60:40 w/w, J.T. Baker) cermet and the electrolyte film consisted of YSZ (Tosoh). These materials were simulated in ABAQUS as well as manufactured using a combination of tape-casting and a modified spray-coating procedure.

Finite Element Analysis

Table 1, below, shows the material properties used in this model obtained from various sources. The given Young's modulus is reduced for the anode to include the material porosity using a linear relationship as shown in Eqn. (1) where b is 2.10 and p is estimated to be 15% based off similar samples produced through tape casting. This porosity was also verified experimentally using the water and then alcohol immersion techniques.

E=Eₒ(1−bp) (1)

TABLE 1
Temperature dependent material properties
of ceramic composite materials.

| | | | Young's | Reduced |
|---|---|---|---|---|
| Material | Temperature | TEC | Modulus | Modulus |
| Component | (K) | (×10\hat{ }−6K) | (GPa) | (GPa) |
| NiO—8YSZ | 300 | 3.8 | 183 | 125 |
| Anode | 600 | 5.9 | 176 | 121 |
| | 900 | 8 | 181 | 124 |
| | 1200 | — | 181 | 124 |
| | 1500 | — | — | — |
| 8YSZ | 300 | 7.9 | 215 | — |
| Electrolyte | 600 | 9.2 | 185 | — |
| | 900 | 10.4 | 156 | — |
| | 1200 | — | 157 | — |
| | 1500 | — | 160 | — |

A static, implicit two-dimensional model was used in the present invention. The sintering cooldown was staged to allow for variations in material properties from the peak sintering temperature of 1350° C. to ambient temperature. Linear interpolation was used between known values to provide continuous material property data. For high temperatures, the maximum value of TEC and Young's Modulus was used. Limited information is available for these elevated temperatures. The main characteristic not captured in this model is creep stress relaxation. This is a time dependent process and cannot be calculated in a static model. Over short time periods creep is minimal, but with extended sintering cooldowns at temperatures well in excess of 50% the material melting temperature, this behavior is expected to have an impact on the residual stresses within the composite. Future work will use dynamic modelling to include this parameter. Nonlinear geometry was also selected due to the large deformation expected with this structure.

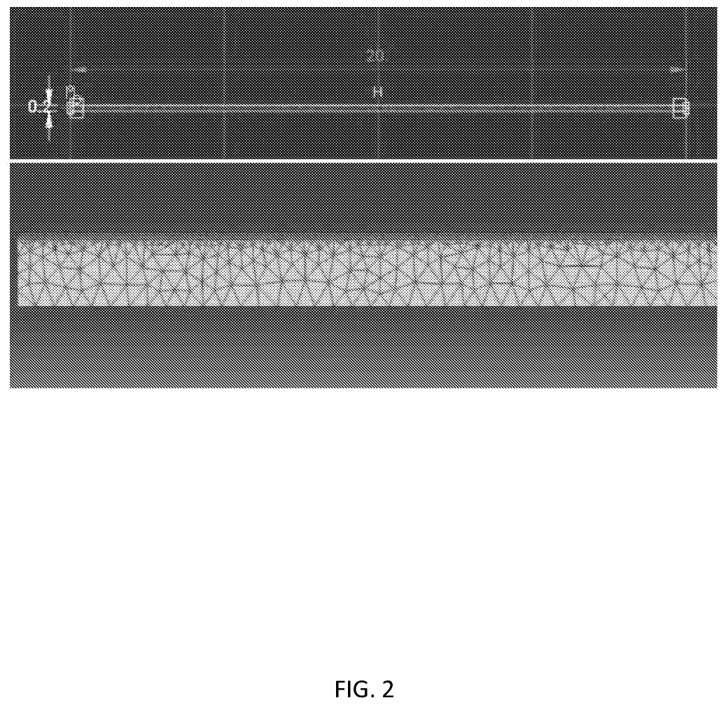

The model was a constant 20 mm×0.2 mm (FIG. 2, top) with a ratio of anode to electrolyte thickness varying from 0.99 to 0.5. All material properties, model dimensions, and thermal history remained consistent for each trial with the only variable being the anode/electrolyte ratio. For most cases, the anode was significantly thicker than the electrolyte, so a coarser mesh was used with edge seeds of 0.05 mm on the external surface. At all four surfaces bounding the electrolyte, the edge seed was chosen to be 0.01 mm to yield a fine mesh. This mesh is shown in FIG. 2, bottom. Triangle elements were chosen to accommodate the variation in mesh size throughout the specimen.

Three-dimensional simulation was also carried out where a square sheet with side length of 10 mm and thickness of 0.4 mm was coated with a film of 5% the thickness of the composite. The material properties and temperature program was repeated from the two-dimensional simulation. Mesh consisted of cubic elements with side length 0.02 mm.

Experimental Manufacturing

Manufacturing began with tape-casting of the anode substrate. NiO-YSZ powder, solvents, and binders were mixed until homogenized into a tape casting slurry. While the slurry was mixing, a doctor blade was calibrated using thickness gauges and mounted to the bed of the tape casting chamber. When adjusting the blade heights, the inner of the two was set to twice that of the outer blade to filter out any large impurities in the slurry. For a final green film thickness of 300 μm, the outer and inner blade heights were set to 1,500 μm and 750 μm respectively, accounting for the 60% thickness reduction due to the drying process. Once the slurry had milled for 48 hours, it was poured into the doctor blade's hopper and distributed on top of the plastic film being drawn through the caster. This film dried within a well-ventilated chamber for −10 minutes and then was collected on a roll.

These dried anode tapes were then coated with a YSZ film. YSZ was deposited with the use of a computer numerical control (CNC) ultrasonic spray machine (ExactaCoat, SonoTek) allowing for the precise control of film thickness. A slurry consisting of YSZ, solvent, and dispersant was milled for 48 hours, then fed into an automated syringe pump which was connected to the spray machine. To apply uniform films, the CNC sprayer deposited 210 layers of electrolyte while moving at a constant speed over the film and pausing between layers to allow for the coating to fully dry. This results in an electrolyte thickness of −20 μm. To produce patterned films, a polymer mask was used which blocked selected areas of the film from the spray. If it was desired to coat both sides of the sheet with the patterned film, the spraying process was simply repeated on the other side. The complete process is shown in FIG. 1. Once the film was deposited, the anode-electrolyte sheets were sintered. Heating rates were maintained at 1° C. min⁻¹ with a two-hour hold at 100° C. to facilitate the burnout of organic solvents, and a 4-hour hold at the peak sintering temperature of 1350° C. Cooling rates were maintained at 0.5° C. min⁻¹ with 6-hour holds at 800° C. and 600° C. to promote creep stress relaxation, avoiding critical stress concentrations.

Results and Discussion

Two-Dimensional Simulation

The curvature K of a bilayer strip can be related to the tension within the contracting film σ_{f} as well as the thicknesses of the substrate and film. This is shown in Eqn. (2) where additional parameters include the substrate Poisson ratio v, and the substrate Young's modulus E.

$$\\ \begin{matrix}{σ}_{f} = \frac{{E}_{s} {t}_{s}^{{}^{} 2}}{6 ( 1 - {v}_{s} ) {t}_{f}} κ & ( 2 )\end{matrix}$$

This formula has been shown to be accurate for film thicknesses up to 10% of the substrate thickness, with improved accuracy if the film and substrate moduli are similar. It can be seen from this expression that the curvature and ratio of substrate thickness squared to film thickness defined are proportional to each other, this is shown in Eqn. (3).

$$\\ \begin{matrix}\frac{1}{κ} = r ∝ \frac{{t}_{s}^{{}^{} 2}}{{t}_{f}} ≡ τ & ( 3 )\end{matrix}$$

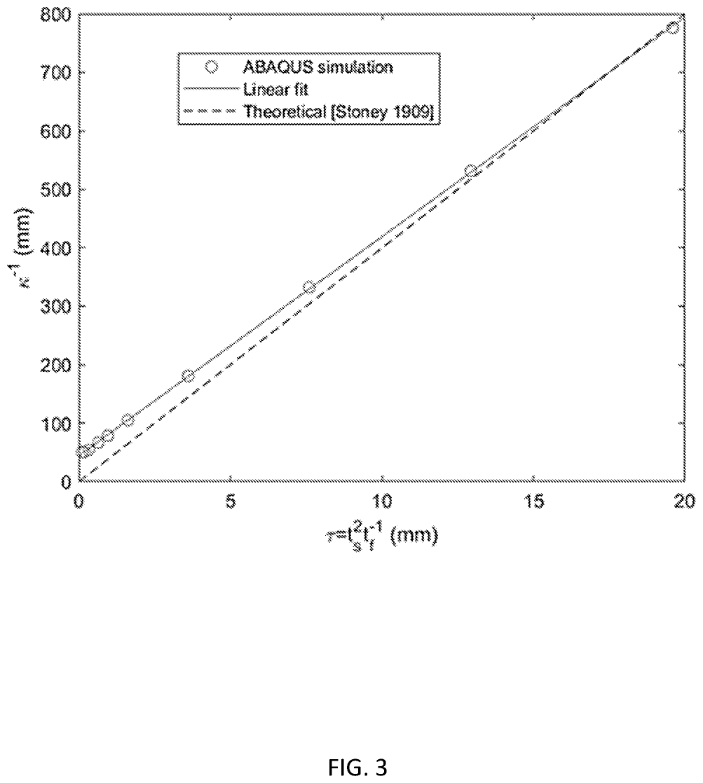

After performing all simulations and plotting τ against inverse curvature as suggested by Eqn. (3), an obvious trend emerged as shown in FIG. 3. All trials conformed well onto a linear fit. A theoretical model where the y-intercept is set to zero is also provided in FIG. 3, representing the trend expected by the Stoney equation where a zero-value for τ (an applied film which is infinitely thicker than the substrate) corresponds with an infinite curvature K. Though a strong linear trend is shown in the data obtained in this work, there is an obvious deviation from the theoretical model corresponding to a non-zero y-intercept. This is an expected result. As previously discussed, this model experiences increasing error at low T. As seen in the figure, however, there is still very good agreement with a linear trend as confirmed by the statistical analysis of the obtained linear trend:

$$\\ \begin{matrix}\frac{1}{κ} ( mm ) = ( 37.5 \pm 0.114 ) * ( τ ) ( mm ) + ( 44.5 \pm 0.903 ) ( mm ) & ( 4 )\end{matrix}$$

Where p-values of 3.19e-11 and 8.28e-18 were obtained for the intercept and slope respectively indicating a very high accuracy of this fit. The slope gives an insight into the value of the leading coefficient in the Stoney equation:

$$\\ \begin{matrix}\frac{{E}_{s}}{6 σ ( 1 - {v}_{s} )} = 37.5 \pm 0.114 & ( 5 )\end{matrix}$$

In addition to the estimation of film stress obtained from the linear fit, there is also the interesting presence of the y-intercept. This intercept corresponds to composites where the electrolyte film has a thickness greater than the substrate and at τ=0 the entire composite is the film. The original Stoney model indicates at this limit, K⁻¹=r=0. This would result in a composite rolled into an infinitely curved tube. Instead, this scenario would apparently have a radius of curvature of 44.5 mm. This makes sense given the non-zero cost to bending of the film itself. This also indicates that all samples with electrolyte film thickness >25% the anode thickness, the degree of warpage remains constant. More generally, for a ceramic composite, there is a limit to the degree of warpage that can be achieved only by varying film thickness.

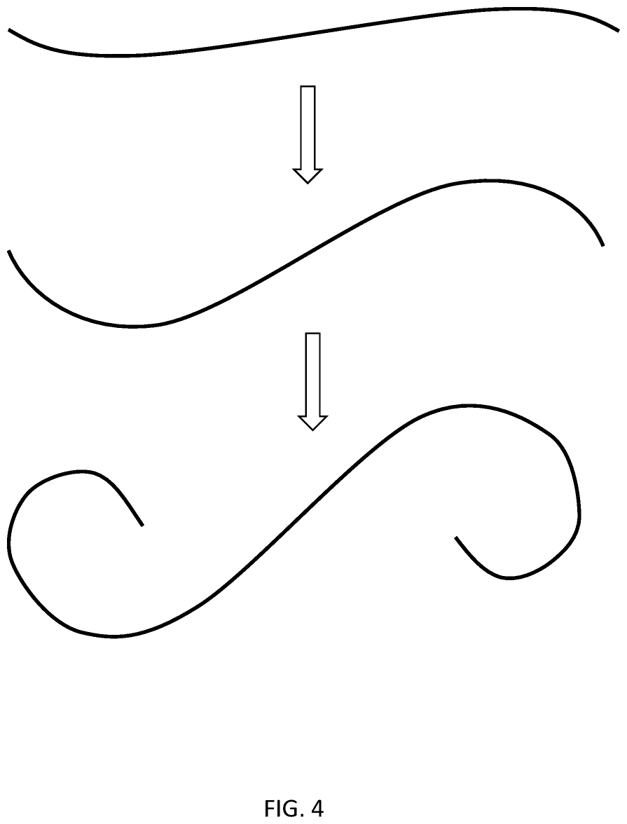

With this understanding of the relationship between curvature and relative film thickness, estimates of real stresses experienced by the ceramic materials can be obtained, a critical task when attempting to avoid material failure. Future work will combine dynamic FEA with molecular dynamics to obtain highly accurate stress predictions which will be compared against experimentally obtained samples. In addition to understanding the stress state of ceramics experiencing bilayer shrinkage, targets for producing complex self-assembling structures can be introduced. In particular, where previous efforts were limited in their ability to control the curvature of the sheet, resulting in constant curvature, these initial investigations demonstrate the ability to have varying curvature as a result of varying applied film thickness. This can be obtained simply by varying the speed of the spray-coater in certain areas generating a thicker film. A simple application of this idea is shown in FIG. 4 where both sides of the substrate are coated with a film of increasing thickness. From left to right, the top film becomes thinner while the bottom film becomes thicker. The evolution of the sheet shape as it is cooled is also shown from top to bottom.

Experimental

Many of the trends observed in experimental work using idealized polymer systems are present in the ceramic medium as well. In particular, there is formation of two distinct “phases.” One where the Gaussian curvature, K as defined by Eqn. (6):

K=K₁K₂ (6)

of the sheet becomes non-zero, resulting in a spherical cap-like shape, and another where the zero Gaussian curvature of the original sheet is maintained as the sheet roles into a tube, i.e. K₁=0, K₂=0. The critical parameters predicting the transition from one phase to another are the stretching and bending energies of the sheet defined by Eqns. (7, 8) respectively where κ₀ is the isotropic curvature of the shell deformation phase and L is a characteristic dimension of the sheet.

Uₛ˜Eh∫_{Δ}(Lk₀)²dA (7)

U_{b}˜Eh³∫_{Δ}k₀²dA (8)

When a sheet originally with zero Gaussian curvature forms a cap with non-zero Gaussian curvature, it must stretch. The separation between cap and tube phase is therefore essentially a competition between whether it is energetically favorable to stretch or to bend. By comparing Eqns. (7, 8), this transition can be characterized by comparing the natural curvature κ₀ which can be predicted from Eqn. (4), and the ratio of the sheet thickness h to the square of the characteristic area L² yielding:

$$\\ \begin{matrix}{κ}_{0} ≪ \frac{h}{{L}^{2}} & ( 9 )\end{matrix}$$

Sheets with low curvature that are relatively thick will prefer to stretch into a cap than to bend.

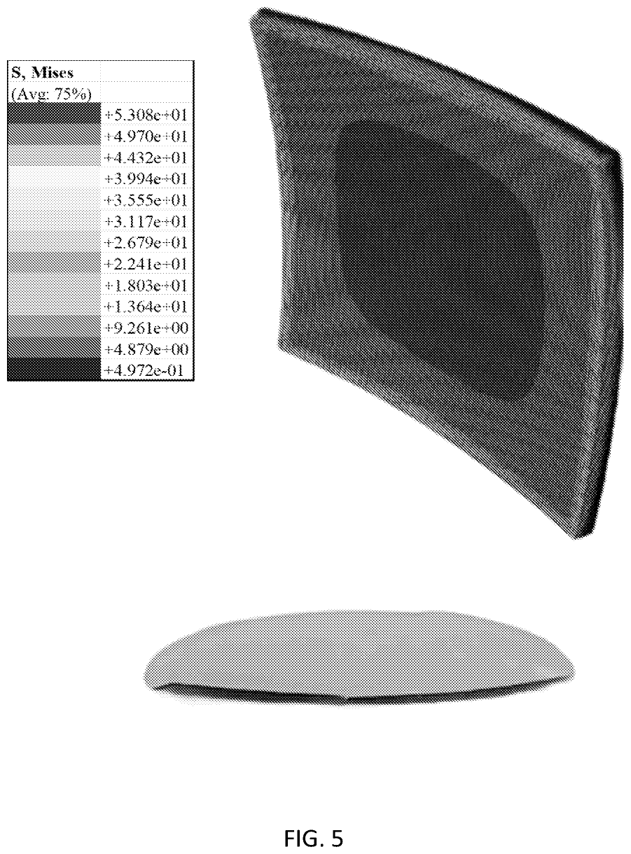

This behavior is often seen with dry-pressed SOFCs which tend to have a thick anode relative to the anode surface area. The thickness of the cell shown in the bottom of FIG. 5 was 450 μm and had a characteristic area of 133 mm². This corresponds to a value of 0.0034 mm⁻¹ following Eqn. (9). The natural curvature as predicted by Eqn. (4) is 0.0029 mm⁻¹. When the two-dimensional model developed previously is extended to a three-dimensional model with similar dimensions to the dry-pressed cells corresponding to a characteristic curvature of 0.004 mm⁻¹ and natural curvature of 0.0024 mm⁻¹, both can be seen to exhibit the cap-like shape caused by energetic preference for stretching (FIG. 5) due to their relatively high thickness and similar order of the natural and characteristic curvatures.

As the sheet becomes thin relative to its size, tube-like deformation is expected. All samples prepared with tape casted anode substrate were shown to exhibit this behavior. Typical dimensions of a sheet were a thickness of 250 μm with typical characteristic areas of 225 mm². This yields a characteristic curvature of 0.0011 mm⁻¹ and natural curvature of 0.006 mm⁻¹. As expected, the characteristic curvature is less than that for the dry-pressed shell-forming sample and because the characteristic curvature is less than the natural curvature, bending is preferred over stretching.

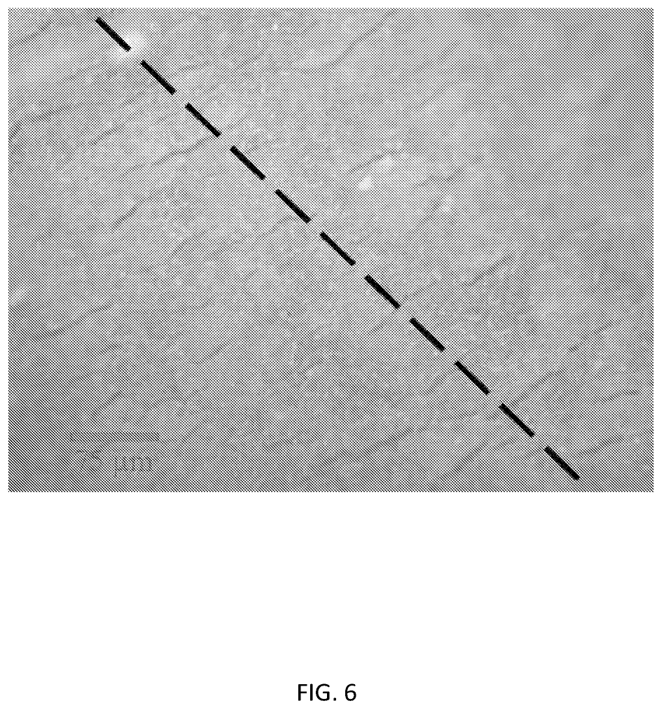

Furthermore, the orientation of the directions with κ₁=0 and κ₂≠0 can be predicted. The sheet will tend to bend the longest axis of symmetry. For example, with a rectangle, the two shorter sides will bend towards each other forming a short thick tube as opposed to a long thin tube. Within the ceramic medium studied here, these behaviors were not followed absolutely. It can be seen in FIG. 6 that a variety of complex shapes were formed other than the expected tube with a height less than its diameter, as would be formed by a rectangular sheet bending its longer axis of symmetry. The leftmost sheet has bent the shorter axis of symmetry, forming a long thin tube. For rectangular sheets, the thick tube has lower strain energy than the long tube. The formation of these tubes, however, is heavily impacted by starting conditions. Also, the difference in strain energy between the two shapes is small, often leading to high prevalence of nonideal final deformation orientations. In simulations performed by others, when sheet deformation began with no initial curvature in any direction, the thick tube was formed exclusively. When a small curvature was imposed on the shorter axis, the thin tube was formed. To transition from this initial bend of the shorter axis to bending the longer axis, the sheet must either transition through a state of non-zero Gaussian curvature or through a state where the sheet is entirely flat, neither of which are feasible transitions. The impact of starting condition and anisotropy of the sheet combined with relatively small difference in strain energy between deformation orientations can explain the seemingly unexpected tube shape seen in the left of FIG. 6. Furthermore, misorientation of bending direction may be less than the 90 degrees exhibited by long thin tubes resulting in spring-like spirals as seen by the two sheets on the right of FIG. 6.

In addition to unexpected directions of deformation, the deformation patterns formed were often chaotic. As seen in FIG. 6, the sample second to the left has several regions of changing curve orientation. This complex deformation pattern has not been as prevalent in previous work due to the robustness of the more ideal polymer system. If small variations in the bilayer are introduced, frustrations arise. This is clearly shown with the ceramic composites studied here where even though the deformation continues to maintain a zero Gaussian curvature, imperfections within the composite, a common occurrence with porous ceramics, lead to instabilities within the sheet and geometric frustrations as it does misorientation of the direction of bending from that predicted by a minimization of sheet strain energy. As shown in Eqn. (1), the Young's modulus of ceramic materials is a function of its porosity. Nonuniform distribution of solvents, binders, and pore formers within the slurry used in tape casting contribute to anisotropy of these sheets causing the behaviors observed in FIG. 6. Nonuniform film deposition and substrate thickness can also contribute. Overall, the complexity of the shapes formed reveals the intricacies of the ceramic medium which is only sometimes demonstrated with closer to ideal polymer systems.

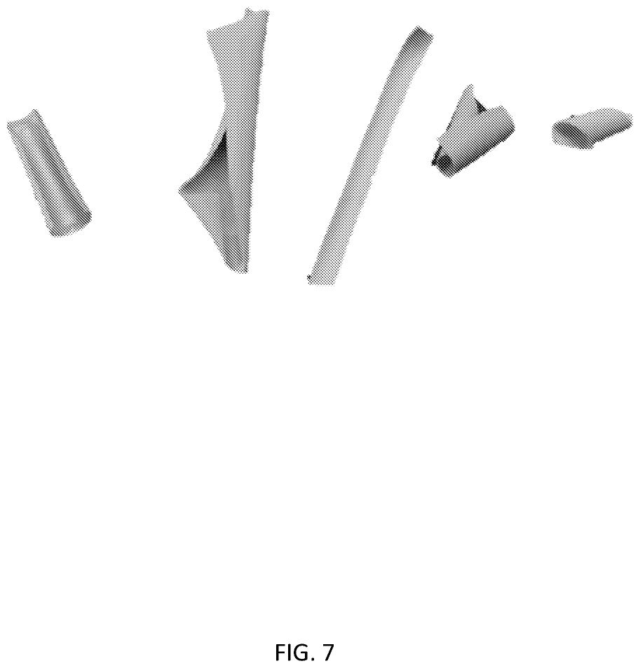

In addition to frustrated deformation patterns at the macroscale, at the microscale unexpected behaviors are present as well. When the ribbon in the center of FIG. 6 was viewed with an optical microscope, small cracks −50 μm in length were seen on the surface as shown in FIG. 7. They also all appeared to be aligned with each other, perpendicular to the axis of curvature of the ribbon (indicated by the black dashed line). Although these ceramic sheets are able to resolve residual stresses as a result of cooling from peak sintering temperature by bending in one direction, in the perpendicular direction, the rigidity imposed by the need to conserve the zero Gaussian curvature of the starter sheet prevents dissipation of residual stresses. As a result, the tension within the electrolyte film is resolved by fracturing. This is a behavior commonly seen with geometrically constrained SOFCs such as with tubular geometries. An effective method to resolve this issue is by utilizing extended sintering cooldown procedures which promote creep stress relaxation. This method can similarly be applied here to eliminate these microcracks, however the desired deformation of the sheet will also be reduced. Future work will investigate the coupling of these micro and macroscale phenomena to produce defect free composites.

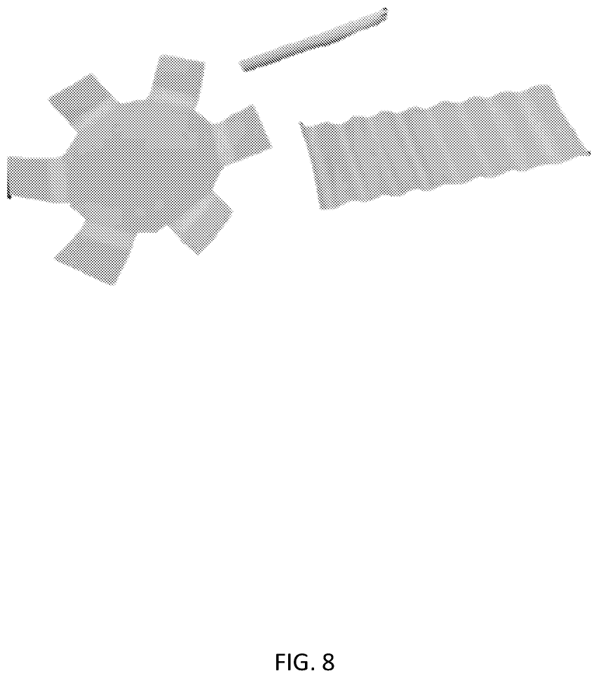

Despite the complexities introduced by the inherently anisotropic medium of ceramics, well-controlled structures were able to be assembled. These are shown in FIG. 8. The leftmost sample shows the “sunflower” which demonstrates the ability for this technique to form hinges commonly used in self-assembling origami and kirigami techniques. The tube cell in the center demonstrates the ability to form a structure desirable in many SOFC applications. Finally, the rightmost sample demonstrates the ability to form valley and mountain folds by patterning both sides of the substrate. These techniques combined demonstrate the potential of the methods developed here to produce a variety of complex ceramic shapes not obtainable with traditional manufacturing.

Ceramic sheets can be shaped by applying a thin, contracting film. The curvature of the sheet can be predicted using historical investigations into the bilayer shrinkage problem, and the overall shape can also be predicted, though imperfections synonymous with the ceramic medium often generate a rich variety of complex, frustrated geometries. The initial efforts shown here motivate the continuation of this research both in the fundamental investigation of the bilayer shrinkage problem within the ceramic medium as well as powerful applications of this idea in a variety of systems.

### Example 2

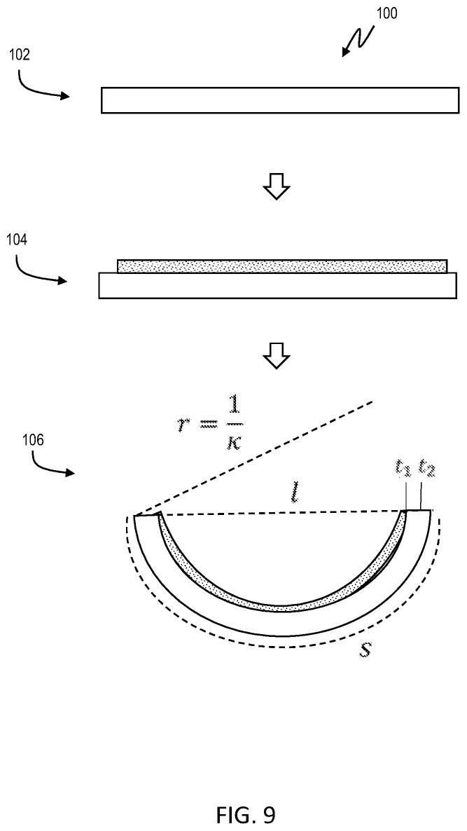

Referring to FIG. 9, preparation of experimental samples began with tape casting 102 of the NiO+(Y₂O₃)_{0.92}(ZrO₂)_{0.92} (60% wt/40% wt, NiO+YSZ, Tosoh). Blown fish oil, toluene, and ethanol were ball-milled for approximately a half hour, then added to NiO+YSZ powder. After milling for 24 hours, polyvinyl butaryl, benzyl butyl phthalate, and additional ethanol were added, and the resulting mixture was ball-milled for at least 48 hours. To prepare the tape, a doctor blade was set at a height 250% the desired final sheet thickness to account for the approximate 60% reduction in thickness that occurs during drying and sintering. The ceramic slurry was then cast onto a plastic film using a HED International Lab-Cast Tape Caster. After an hour, the tape was dry and could be sprayed.

For spraying, a slurry of YSZ, ethanol, and glycerol was prepared via ball-milling for at least 48 hours. The tape cast green films and slurry was added to a Sonotek ExactaCoat Ultrasonic Spray Coater. The film was then sprayed 104 with 420 layers of YSZ to build an approximate film thickness of 20 μm. To form 2D sheet shapes, the sprayed sheet was cut using circular dies in addition to rectangular stencils used with a scalpel. The cut sheet shapes were then placed onto an alumina plate for sintering.

The sintering procedure 106 consisted of heating to 600° C. at a rate of 2.5° C. min⁻¹. The temperature was then held at 600° C. for half an hour. After the hold, the furnace temperature was brought to 1350° C. at a rate of 4.2° C. min⁻¹. This temperature was held for 4 hours. The samples were cooled to 800° C. at a rate of 6.1° C. min⁻¹. Final cooling to room temperature was carried out at 2.5° C. min⁻¹. FIG. 9 shows a flow-chart of this process as well as the key quantities obtained for analysis.

To measure the radius of curvature r of samples with arc lengths 2≥πr, the inner and outer diameters of the sample were measured using calipers and then the average was taken to obtain twice the mid-plane radius of curvature. For shorter arcs (like that shown in FIG. 9) with s<πr, the distance from arc edge to edge, or the chord length, l was measured, and the arc length s was obtained by measuring the length of the flat axis in the case of 2D disks and squares deformed in the tube-like mode. Rectangles deforming in this way with short arc lengths were not observed within the sheet parameters studied.

Interestingly, the chord length and arc length may be related to the arc angle as follows:

$$\\ \begin{matrix}\frac{2 sin ( \frac{θ}{2} )}{θ} = \frac{l}{s} , r = \frac{s}{θ} & ( 10 )\end{matrix}$$

which is an implicit equation and can therefore not be solved directly. Newton's method was used to iteratively solve this equation with initial guess calculated by inscribing an isosceles triangle and taking the lengths of the hypotony.

Thicknesses of the substrate and film were obtained using a JEOL-JSM-5600 scanning electron microscope (SEM). Samples were prepared by fracturing and imaging in secondary electron mode with a beam potential of 10 kV.

2D FEM simulation was carried out as described in previous work [9] using temperature dependent TECs and Young's Moduli as shown in Table 2 obtained from various sources [20-25]. The Young's modulus was reduced for the anode to address the impact of porosity using a linear relationship with porosity estimated to be 15% based off similar samples produced through tape casting and verified by alcohol and water immersion method measurement.

TABLE 2
Temperature dependent material properties of NiO—YSZ and YSZ

| | | | Thermal Properties | |
|---|---|---|---|---|
| Elastic Properties | | | Thermal | |
| Young's | Poisson's | Temper- | Expansion | Temper- |
| Moduli, E | Ratio, | ature | Coefficient, | ature |
| (Mpa) | v | (Celsius) | 1/T (10E−6) | (Celsius) |
| Nickel oxide-yttria | | | Nickel oxide-yttria | |
| stabilized Zirconia | | | stabilized Zirconia | |
| 141000 | 0.3 | 300 | 3.80E−06 | 300 |
| 135000 | 0.3 | 600 | 5.90E−06 | 600 |
| 139000 | 0.3 | 900 | 8.00E−06 | 900 |
| 139000 | 0.3 | 1200 | | |
| YSZ Film | | | YSZ Film | |
| 215000 | 0.3 | 300 | 7.90E−06 | 300 |
| 185000 | 0.3 | 600 | 9.20E−06 | 600 |
| 156000 | 0.3 | 900 | 1.04E−05 | 900 |
| 157000 | 0.3 | 1200 | | |

The 2D model was a constant 20 mm long strip with appropriately varying thickness of substrate and film. For most cases, the anode was significantly thicker than the electrolyte, so edge seeds of 0.05 mm were used on the external surface. 0.01 mm seeds were selected for the electrolyte. Triangle elements were chosen to accommodate the variation in mesh size throughout the specimen.

The 3D model was modified from previous work to account for the material behaviors unique to ceramics. This consisted of a composite shell meshed with 0.2 mm seeds and quadrilateral elements. A section was defined with a substrate consisting of NiO-YSZ and film of YSZ with appropriately varying thicknesses of each layer. 3 integration points were used for both layers. Boundary conditions were prescribed such that the four corners of the sheet remained in the x-y plane the shell was originally defined in. By obtaining the displacement in the x direction for the far edge able to move in the x-direction, the chord length of the sheet could be obtained and compared against the arc length to determine the curvature of the sheet using equation 10. For complex film patterns, the sheet was partitioned. The composite was defined differently within these partitions to replicate film coating on the top or bottom of the sheet as well as the absence of film.

The 2D and 3D FEM models were static, implicit two-dimensional models executed in ABAQUS. The sintering cooldown was analyzed in this model with a homogenous predefined temperature field of 1350° C. applied to the composite. The second step ramped that elevated temperature down to a room temperature of 22.5° C. Linear interpolation was used between known values to provide continuous material property data. Due to the large degree of deformation expected, the step included nonlinear geometry effects.

The curvature a bimaterial composite obtains as both materials shrink due to a change in temperature is well-understood. In this work Timoshenko's analytical model will be used. This prediction is shown by equation 11:

$$\\ \begin{matrix}{κ}_{0} = \frac{6 ( {α}_{2} - {α}_{1} ) ( T - {T}_{0} ) {( 1 + \frac{{t}_{1}}{{t}_{2}} )}^{2}}{( {t}_{1} + {t}_{2} ) ( 3 {( 1 + \frac{{t}_{1}}{{t}_{2}} )}^{2} + ( 1 + \frac{{t}_{1} {E}_{1}}{{t}_{2} {E}_{2}} + \frac{1}{\frac{{t}_{1} {E}_{1}}{{t}_{2} {E}_{2}}} ) )} & ( 11 )\end{matrix}$$

where a is the TEC, T−T₀ is the temperature change, t is the component thickness, E is the Young's modulus, and the subscripts 1 and 2 refer to the film and substrate respectively.

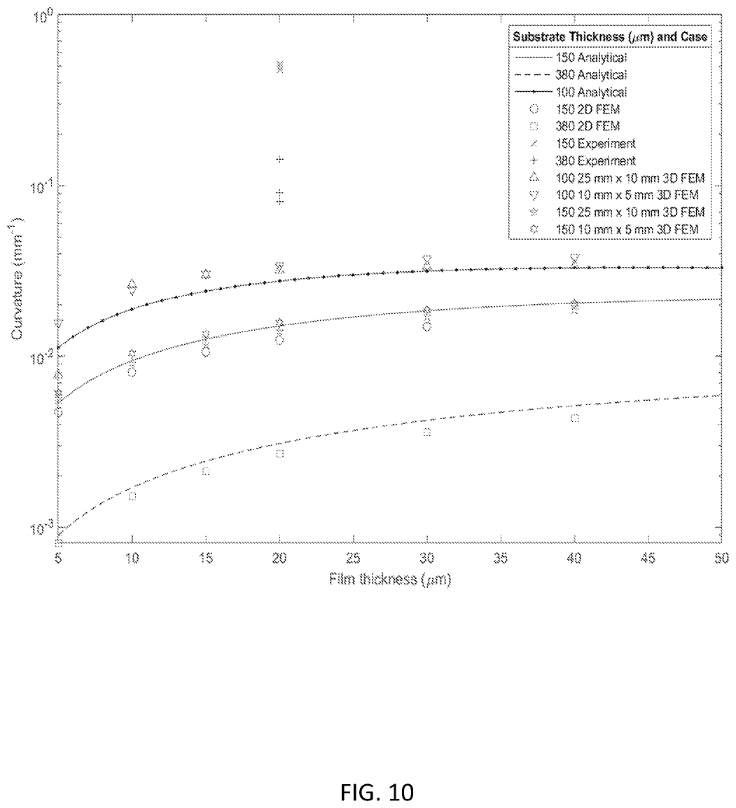

This model is shown in FIG. 10 as “Analytical” for substrate thicknesses of 100 nm, 150 nm, 380 nm. The 2D FEM curvatures are also plotted. Rectangles of size 25 mm×10 mm and 10 mm×5 mm with 100 nm substrate thicknesses are shown for 3D FEM curvatures. Experimental samples with substrate thicknesses of 150 nm and 380 nm are shown with a film thickness of 20 nm.

As can be seen in FIG. 10, the analytical model and FEM simulations agree well with each other for film thicknesses >−10 nm. Sources of small disagreements come from the need to use average TECs and Young's Moduli in the case of the analytical model. The 3D FEM simulation also captures the influence of edge effects on deformation and increased stiffness as a result of small degrees of curvature causing an increase in the second moment of area perpendicular to the primary axis of curvature. These effects are particularly pronounced at low film thicknesses.

The much larger disagreement is between all models and the experimental samples. It can be seen that the curvature obtained experimentally is an order of magnitude greater than that predicted by modeling approaches for the same film and substrate thicknesses. Linear shrinkage of the ceramic materials as a result of sintering could be an explanation for this discrepancy. This would require the assumption that the zero-stress, flat state is not at the peak sintering temperature as the ceramic becomes one solid composite, instead it is at room temperature at the beginning of the sintering temperature with linear shrinkage and TEC mismatch causing the composite deformation. This explanation, however, is unlikely. The linear shrinkage of porous NiO-YSZ is greater than fully dense YSZ. This would cause the composite to curve towards the NiO-YSZ instead of the YSZ as is observed in experiment, so including the influence of linear shrinkage would only decrease the overall curvature predicted.

While the explanation for the discrepancy between experiment and modeling is elusive, a methodology to predict the curvature and shape obtained in experiment is not. The TEC of the film may be adjusted until the model curvature lines up with the experimental curvature. Often with ceramics manufacturing analytical predictions for the outcome of a process are highly inaccurate due to the large number of coupled behaviors. For example, predicting the film thickness produced via tape casting involves knowledge of surface tension, gravity, adhesion, cohesion, and of course drying behavior as discussed above. Often empirical relationships are used in place of these analytical predictions given these inherent difficulties. Here a similar approach was used where an empirically derived TEC was used in place of that obtained from literature.

Following literature, the average TEC for NiO-YSZ and YSZ from 1350° C. to 22.5° C. are 7.3.10⁻⁶ K⁻¹ and 1.00·10⁻⁵ K⁻¹ respectively. If the YSZ TEC is increased to 9.10⁻⁵ K⁻¹, agreement is obtained between experiment and modeling. The shape of sheets experiencing bilayer shrinkage is determined by the 2D sheet shape, thickness, and curvature. By obtaining measurements of these dimensions and predictions of curvature that are consistent with experiment, final shape can be accurately predicted regardless of the reason for the curvature discrepancy. This modified TEC is used in FEM modeling for the deformation shape analysis.

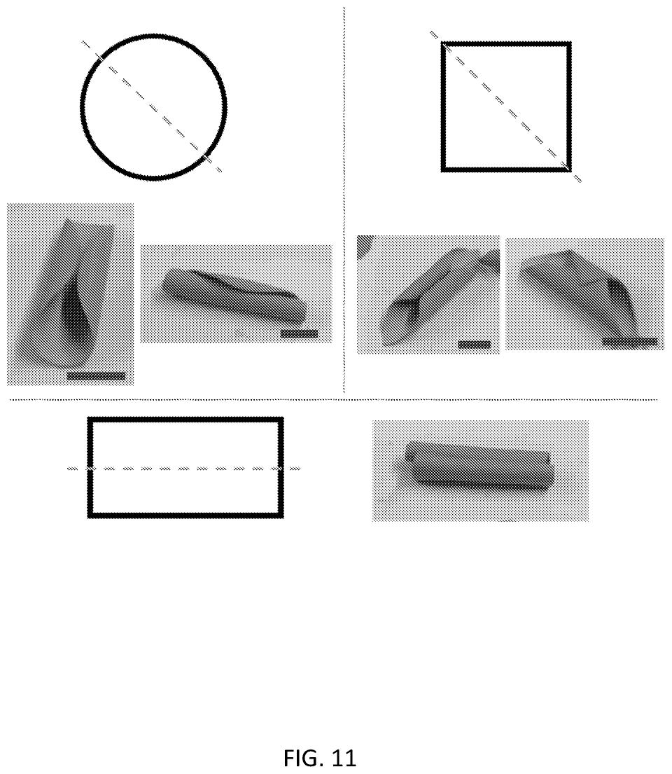

Experiment and modeling was used to compare behaviors of the ceramic system to those already understood with polymer and metal materials. One of the defining behaviors of sheets deforming due to bilayer shrinkage is the tendency to bifurcate between deformation mode. Others have shown that this results from a comparison between bending and stretching energies. In this study, all sheets were within the regime of thickness and sheet size to experience bending deformation where the Gaussian curvature of the sheet remains zero. Predictions regarding the direction of the non-zero principal curvature were also made. The overarching rule is the longest line of symmetry will become the non-zero principal curvature. For circles, the axial symmetry introduces no preferred orientation of bending, producing taco-like shapes as seen on the left side of FIG. 11. For squares, the longest line of symmetry is the diagonal (as marked by the dashed line). For rectangles, the longest line of symmetry is the major axis of the rectangle. As shown in FIG. 11, this is the axis that bends with the shorter edge remaining straight. These predictions are consistent with what is observed experimentally, indicating the predictions are valid regardless of material. As a result, the deformation shape and transition between deformation mode can be predicted for a wide variety of canonical 2D sheet shapes and dimensions yet to be produced experimentally.

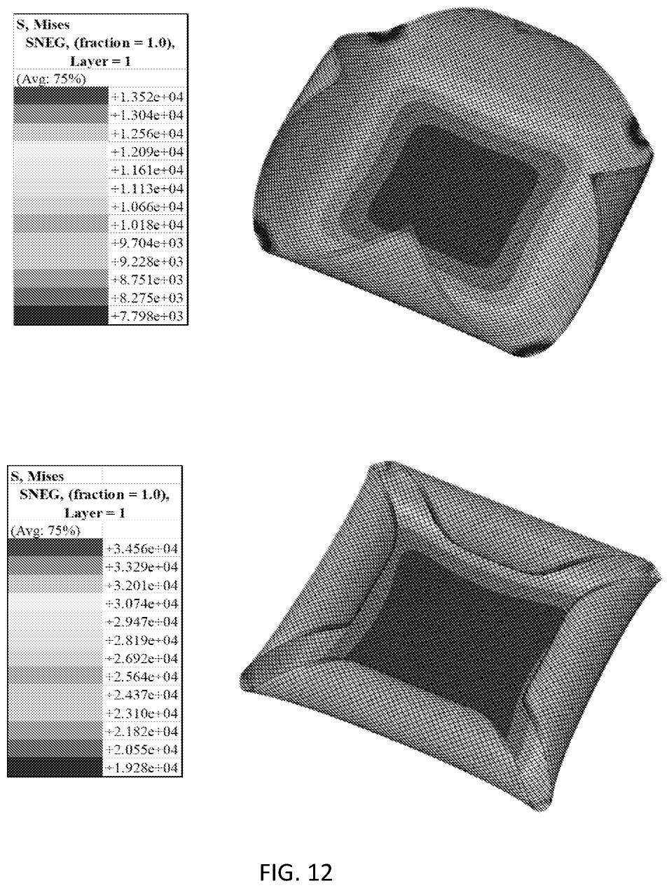

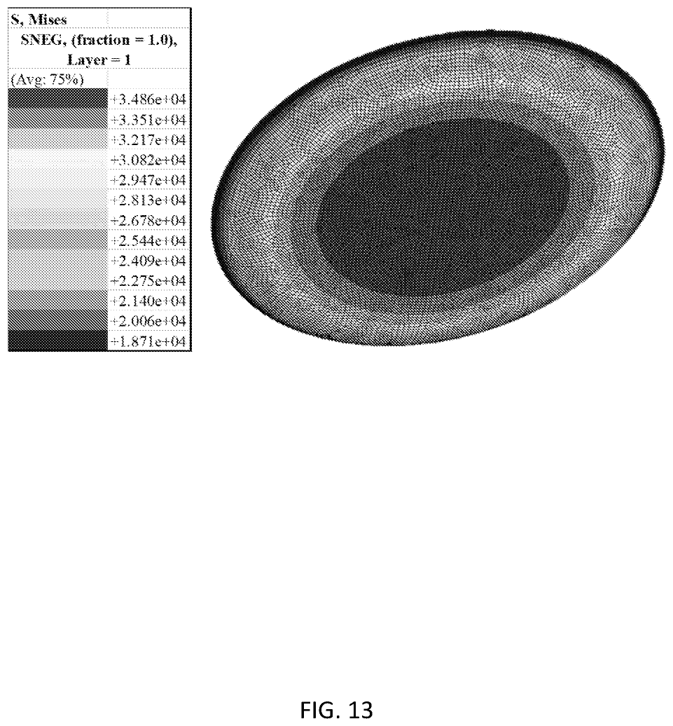

While experiment aligns with predictions from other materials, the current ABAQUS composite model does not effectively predict deformation for highly symmetric shapes. As seen with squares and circles, the shape that is expected as shown in FIG. 11 does not occur, instead all four corners bend equally as shown in FIG. 12 and a fully symmetric stretching deformation is experienced for circles as shown in FIG. 13. By restricting the areas which can deform in a sequential manner towards the center of the sheet, the unexpected deformation mode shown here has been observed. This was achieved in bilayers with adhesion to the support surface, but was not seen in modeling or experiments where the bilayer was entirely free from the supporting surface. This indicates formation of taco-like modes is dependent on the entire sheet deforming simultaneously with distant regions impacting each other. This behavior is not well captured with the FEM model executed in ABAQUS. The method used by Alben et al. involved directly minimizing the Foppl-von Karman equations which describe the elastic energy of plates undergoing moderate out-of-plane deflection. This method more accurately predicts the final shape and avoids local minima of potential energy that commercial software like ABAQUS can determine as the final solution. Expanding this analytically driven modeling to arbitrary film pattern and sheet shape, however, is prohibitively difficult.

Attempts were made to address the issues observed with the ABAQUS model by increasing the fineness of the mesh and including biasing towards the outer edges of the sheet. The desire was to better capture the behavior at these edges where Alben et al. showed the deformation shape is determined. Despite these changes to the mesh, no change in behavior was observed for the square or circular shapes. Fully addressing this issue will be a topic of future investigations.

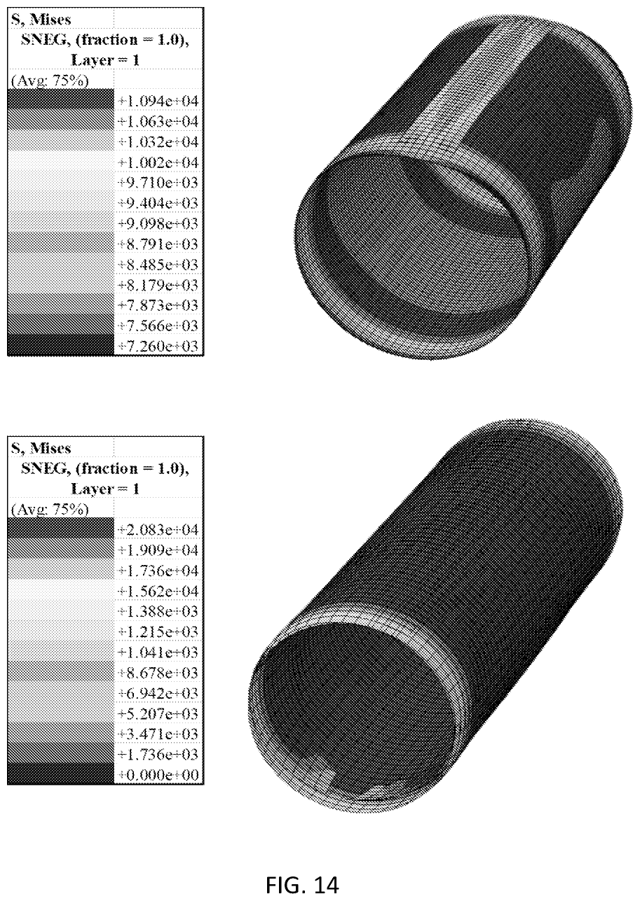

Many behaviors are well-captured by this simple composite shell model. In particular, the transition from bending orientation following the diagonal of the square to the major axis of the rectangle is shown to occur. FIG. 14 shows a rectangle with dimensions of 20 mm×10 mm and substrate and film thicknesses of 150 μm and 20 μm respectively. As can be seen, the major axis is curved while the minor axis remains flat. Small regions of non-zero Gaussian curvature can also be observed at the edges of the sheet. The prediction of this deformation orientation was observed to be robust, occurring for sheets with aspect ratios ranging from −1.06 to 25. At an aspect ratio of 1.053, bending orientation as depicted in FIG. 12 was observed, while at an aspect ratio of 1.06, bending orientation as seen in FIG. 14 was observed. This critical aspect ratio has been predicted to be 1.028±0.0025, showing only a 3.1% error from the value predicted using our model. This transition was observed to be independent of the mesh with even extremely fine meshes which fully capture the influence of edge effects following the trends observed with coarser meshes. It is also worth noting, this model allows for self-intersection, so at high degrees of deformation, the sheet wraps onto itself. As can be seen in FIG. 11 for experimental samples, this high deformation results in the formation of two adjacent tubular sections in a scroll-like shape, or concentric tubes in a Swiss-roll-like shape.

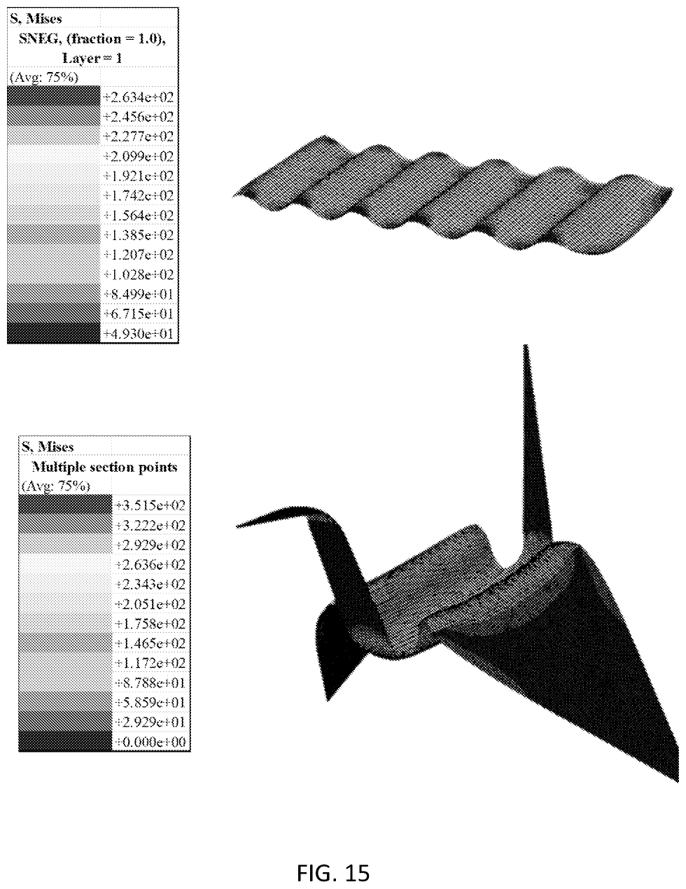

As desired, the model developed here is able to predict behaviors of complex combinations of 2D sheet shape and film where many analytical models face limitations. As seen in FIG. 15, there is strong agreement between the results of the model and experimental sample. This particular example shows a sheet coated with parallel strips of film on the top and bottom of the substrate. In experiment, this is executed by applying a mask while spraying with film and then repeating on the other side of the substrate. The resulting structure has a wave-like pattern.

Finally, this model allows for the design of very complex objects such as those commonly found in origami. By combining sections with film coating on either the top or bottom of the substrate with regions with no film, following an origami folding pattern, a 2D sheet cut can be made to fold itself into the classic origami crane as shown in FIG. 15. This structure serves as a demonstration of the ability to generalize this model to any arbitrary final 3D form, allowing the design of masks and spraying processes to produce these intricate shapes.

The ability to design 2D sheet shape and film pattern to produce a final 3D geometry was evaluated by producing experimental samples and comparing against a FEM model developed in ABAQUS. Predictions of curvature obtained by the FEM model and analytical predictions differ from experiment by an order of magnitude, and the source of this disagreement is still a topic of research. By adopting an artificial TEC which matches experiment, 3D FEM models can be made to accurately predict the deformed shape, though some issues are still experienced with highly symmetric sheet shapes.

What is claimed is:

1. A ceramic composite having a complete shape, comprising:
a tape cast ceramic substrate having a first thermal expansion coefficient; and
at least a first film positioned on a first side of the tape cast ceramic substrate having a second thermal expansion coefficient that is different than the first thermal expansion coefficient.

2. The ceramic composite of claim 1, wherein the tape cast ceramic substrate is formed from an anodic material.

3. The ceramic composite of claim 2, wherein the first film is formed from an electrolyte material.

4. The ceramic composite of claim 3, further comprising a second film positioned on a second side of the tape cast ceramic substrate and having the second thermal expansion coefficient.

5. The ceramic composite of claim 4, wherein the anodic material comprises NiO and YSZ.

6. The ceramic composite of claim 5, wherein the anodic material has the formula NiO+(ZrO₂)0.92(Y₂O₃)0.08 and the NiO and YSZ are present in a ratio of 60:40 by weight.

7. The ceramic composite of claim 5, wherein the electrolyte material is YSZ.

8. A method of forming a ceramic composite into a complex shape, comprising the steps of:
providing a tape cast ceramic substrate having a first thermal expansion coefficient;
applying at least a first mask having a predetermined geometry to a first side of the tape cast ceramic substrate;
spraying at least a first film having a second thermal expansion coefficient that is different than the first thermal expansion coefficient over the mask and onto the tape cast ceramic substrate;
removing the first mask from the tape cast ceramic composite; and
sintering the tape cast ceramic composite.

9. The method of claim 8, further comprising the step of applying a second mask having a second predetermined geometry to a second side of the tape cast ceramic substrate prior to the step of sintering the tape cast ceramic composite.

10. The method of claim 9, further comprising the step of spraying a second film having the second thermal expansion coefficient over the second mask and onto the tape cast ceramic substrate prior to the step of sintering the tape cast ceramic composite.

11. The method of claim 10, further comprising the step of removing the second mask from the tape cast ceramic composite prior to the step of sintering the tape case ceramic composite.

12. The method of claim 11, wherein the tape cast ceramic substrate is formed from an anodic material.

13. The method of claim 12, wherein the first film and the second film are formed from an electrolyte material.

14. The method of claim 13, wherein the anodic material comprises NiO and YSZ.

15. The method of claim 14, wherein the anodic material has the formula NiO+(ZrO₂)0.92(Y₂O₃)0.08 and the NiO and YSZ are present in a ratio of 60:40 by weight.

16. The method of claim 14, wherein the electrolyte material is YSZ.

17. The method of claim 14, wherein the first mask and the second mask are formed from a polymer.
